(19) United States
(12) Patent Application Publication
(10) Pub. No.: US 2005/0204650 A1
(43) Pub. Date: Sep. 22, 2005

(54) Personnel detention structure and system

(76) Inventor: Timothy J. Tobin, Peoria, IL (US)

Correspondence Address: Paul H. Gallagher, 2439 Jackson Ave., Evanston, IL, 60201, US

(21) Appl. No.: 10/805,549

(22) Filed: Mar. 22, 2004

(51) Int. Cl. E04H 3/08; G02B 6/36

(52) U.S. Cl. 52/106

(57) ABSTRACT

A detention structure made up of a plurality of modules all of which are similar to each other, and in basic structure identical. They are connected together to form a single main structure. In the main structure, each of the modules performs an independent function. Each modules has an inner end and an outer end, the inner end being connected to another module or structure. The outer end provides an opening to the exterior. The various structures provide different degrees of confinement, such as minimum security, medium security, and maximum security, respectively. The modules can be connected selectively with other modules, or with permanent buildings already existing.

### FIELD OF THE INVENTION

The invention relates to apparatus and system, of detaining persons, thus serving as a jail or prison.

A main object of the invention is to provide such a detention system that is of modular structure including a plurality of modules that can be secured together to form a single unitary structure, thus adapting it to use in connection with overcrowded jails and detention buildings, particularly those in cramped spaces where there is little or no extra space to place conventional jail structures.

The structure of the invention is a modular approach to a solution of what has become an overcrowding condition of jails and penitentiaries. The present structure is designed to provide flexible detention space to meet the specific needs, and provide other advantages to meet all state and federal standards.

A main object is to provide such a structure made up of a plurality of units or modules, that have certain basic features that are identical in all of the modules, but all of which have further details as between modules to render the entire structure of highly flexible nature to adapt the final modular structure to a wide variety of conditions.

Another main object is to provide such a structure in which each of the modules is made up of heavy welded steel that renders each one entirely safe against damage, or fractures that would enable the detained persons to escape therefrom, such as different modules being respectively of such character as to provide minimum security, medium security or maximum security.

More specifically, the structure is designed to provide a solution to offer a wide range of design and floor plans to meet specific space needs. Among certain specific examples the structure can provide optional wiring for intercoms, door locks, and motion detection, and closed circuit T.V. Various arrangements can be provided.

Other advantages are that the structural units or components together can be well adapted to all needs of living within a single final structure, such as central control, offices, visiting, medical, kitchen, eating, recreation, laundry, storage, and nearly any other kind of requirement.

Another object is to provide such a structure that can be adapted to and connected to buildings already in existence, or to stand by themselves as final structures, selectively.

### BRIEF DESCRIPTION OF THE INDIVIDUAL FIGURES OF THE DRAWINGS

FIG. 1 is a perspective view of a detention structure including a plurality of modules connected together in a single building or enclosure, showing the main entrance facade.

FIG. 2 is a perspective view of the structure of FIG. 1 showing the opposite that of FIG. 1.

FIG. 3 is a diagrammatic view of the steel elements used in a single module.

FIG. 4 is a horizontal cross-sectional view through a structure as shown in FIGS. 1 and 2, and including certain selected types of modules.

FIG. 5 is a diagrammatic view of a plurality of modules connected together and connected with a main permanent detention unit.

FIG. 6 is a diagrammatic view of a plurality of structural modules showing another way of interconnecting the various structures.

FIG. 7 is a a diagrammatic exploded view of a plurality of structural modules interconnected in various selected arrangements.

FIG. 8 is a horizontal cross-sectional view showing a single module of a selected kind.

FIG. 9 is a detailed sectional view taken at line 9-9 of FIG. 4.

FIG. 10 is a cross-sectional view taken at line 10-10 of FIG. 4.

### DETAILED DESCRIPTION OF THE DRAWINGS

The modules are identified 20, and individually with the same reference numeral with the letters A, B, etc. The modules are all constructed so that any two of them can be interconnected, independently of any order as between adjacent modules. The opposite ends, and the opposite sides, of each module are parallel, resulting in a rectangular module. Preferably the modules are all of the same size, facilitating interconnecting them.

The overall dimensions of a single module may be approximately 60 feet by 24 feet, but of course the invention is not limited to such precise dimensions.

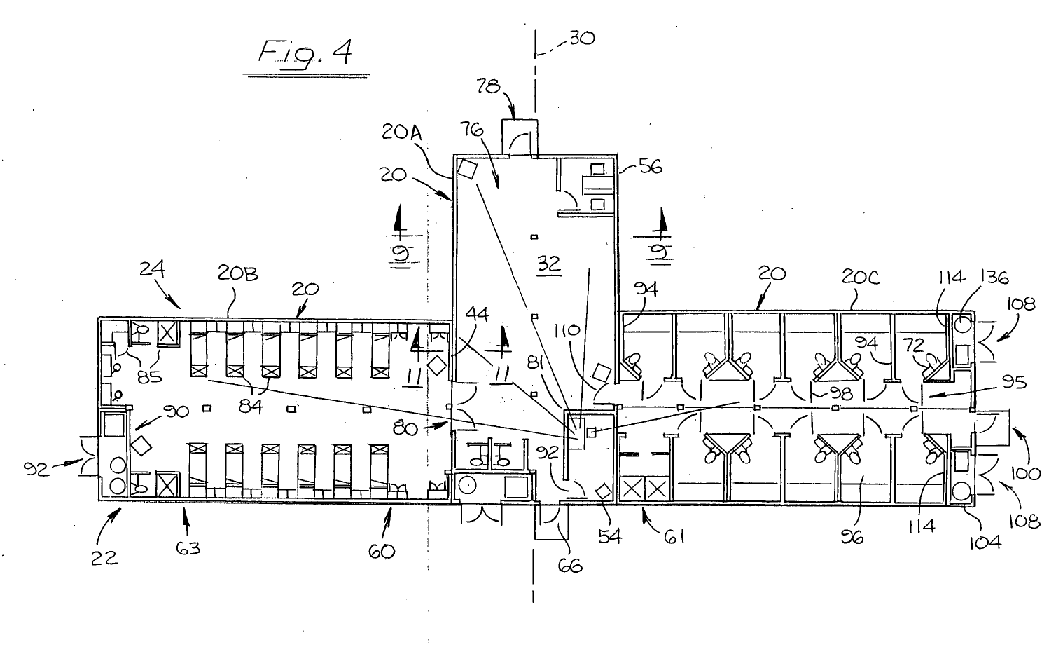

FIG. 4 is oriented according to FIG. 1, with the main entrance facade 22 directed toward the observer, and the exit entrance facade 24 extending away from the observer. FIG. 4 presents both the main entrance facade and the exit facade in the same relative positions as in FIG. 1.

FIGS. 4 and 8 show details of construction of individual modules.

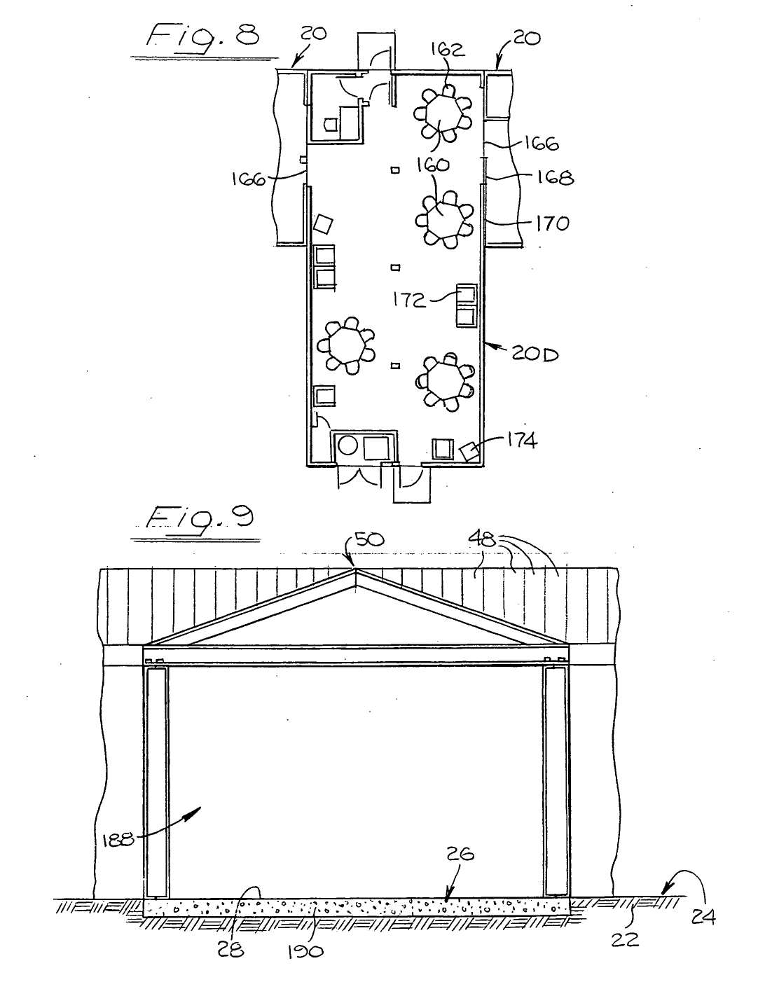

After determining the location of the intended installation of a module, the ground 22 (FIG. 9) is leveled as indicated at 24 and then a slab of concrete 26 is placed on the ground throughout the area where the module is to be supported. This slab forms the floor 28 which serves as the floor throughout the area of that module.

For convenience, attention is directed first to module 20-A of FIGS. 1 and 4. The module is built of two halves 20-A-1, 20-A-2, respectively on opposite sides of a central axis line 30. Located on this line are a plurality of posts 32 of I-beam construction as shown in FIGS. 8 and 9. This post is welded as at 34 to a flat base plate 36 (FIGS. 8 and 9) secured to the concrete floor by anchor posts 40 (FIG. 8) embedded in the floor.

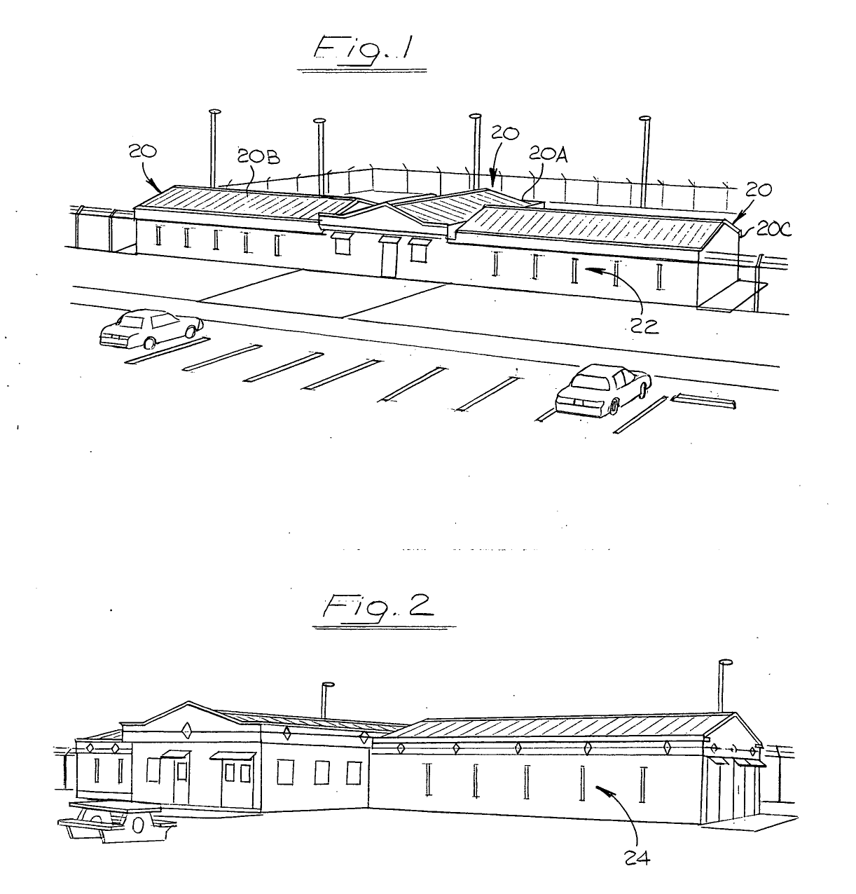

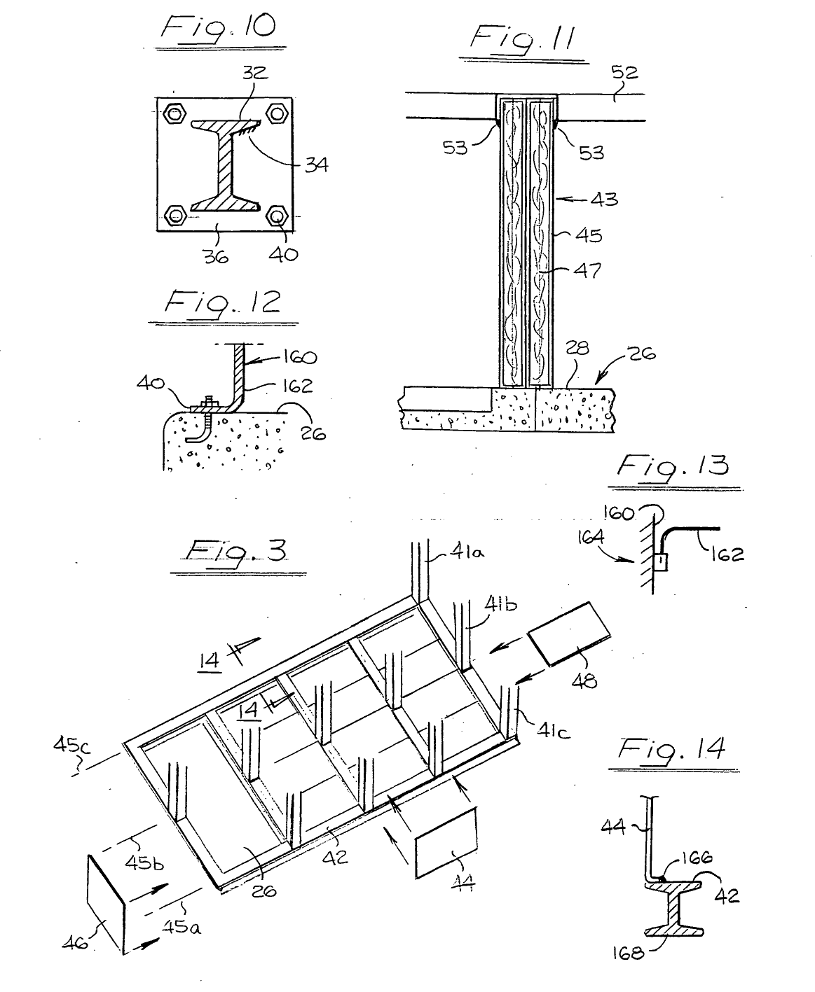

Attention is directed to FIG. 3 which is a diagrammatic view, in partially exploded formation, of the steel framework of a module. This figure shows the concrete floor 26 and beams, in the form of I-beams 42 surrounding the peripheral edges of the concrete floor and resting thereon. The structure also shows posts 45 in the longitudinal rooms 45a, 45b, 45c, those of the central row 45b preferably being taller than the others to provide gable roofs. This figure also shows steel panels 44 which are fitted into the spaces between the posts 45 on one side of the module. Other panels 46 also of sheet steel are fitted to the ends of the framework, and other panels 48 are fitted to the top of the posts thereby being placed in inclined position as shown in FIGS. 1 and 2. These panels may be each in a single piece, or made up of a plurality of pieces in each panel to correspondingly fit the spaces between the posts, as intended.

All of the modules have the basic structure represented in FIG. 4, but the various modules have interior detailed construction according to the specific functions of the different modules, as described herein-below.

In the figures showing the detail inner construction, various elements are used including single-ply, different shapes, and various doors and windows. It will be understood that since this is a detention device the various doors and windows may be of barred construction, walls may be double, and other elements may be shown, also as referred to below. FIG. 10 shows a double wall construction made up of two single walls fitted face-to-face, and each having exterior surfaces constituted by steel sheets 49 and interior insulation 47. The double wall rests on the concrete floor and the upper end engages top rails 52 and welded thereto on both sides as indicated at 53.

Referring to the internal construction of the various modules, attention is directed to FIG. 4, and particularly the central module 20-A therein. In the present instance the arrangement of modules is preselected, and from the standpoint of the description, the entire structure may be considered as randomly selected. In FIG. 4 the main entrance facade 22 is shown at the lower end of the figure, and the module 20-A has an inner end 54 and an outer end 56. The module is oriented according to the other modules with the inner end 54 disposed in engagement with corresponding ends of the modules 20-B and 20-C, the latter modules having inner ends 60, 61 and correlated outer ends 63, 64.

Referring again the the module 20-A (FIG. 4) the inner end 54 has a main entrance door 66 of all steel and mounted in a welded steel configuration, of known kind.

In the following description of the various portions of the device, it will be understood that all openings, such as windows and doors, are of known construction of heavy-welded-steel construction, unless otherwise specified.

Just inwardly of the main entrance door 66, is a cubicle 70, accessible through a door 72. The cubicle 70 serves as a location for a security person having such facilities as a camera, TV, etc.

The module 20-A has a main area 76 which may serve as a day room for the detained persons.

The day room has a exit door 78 leading to the exterior of the structure. Leading from the day room 76, is a double door construction 80.

The wall 81 of the cubicle 70 is relatively low, leaving an open area above it, so that the personal in the cubicle can observe there over, into other cubicles. For example a line 83 represents a line of sight from the personnel in the cubicle into the module 20-B. This condition of sight into the cubicle 20-B extends throughout the area of the module 20-B which serves as a dormitory having double deck beds 84 and other facilities 85 including such as a closets, lavatories, etc.

The inner end of the module 20-B is defined by a wall element 44 constituted by sections or parts on opposite sides of, and defining, the double wall structure 81. This wall element 84 is butted against the side wall of the central module 20-A, this forming a double wall structure as shown in FIG. 10.

All of the modules are of rectangular shape, and are fitted and secured together to avoid any openings or holes.

The module 20-C includes plurality of transverse walls 94 of single or double construction forming a row on each of opposite sides of a central aisle 95, forming cubicles 96 for individual persons. The cubicles being provided with doors 98 communicating with the central aisle. Each cubicle includes facilities for individual accommodation of the persons detained. At the outer end of the module 20-C is a door construction 100 for enabling supervised passage therethrough of persons between the interior of the module and the exterior of the entire structure.

This module 20-C may also be provided with cubicles 104, 106 containing other facilities, and having doors 108 for communication between the present modules (20-C) and other modules of the character disclosed hereinbelow.

One of the transverse walls 94 engages the side wall of the module 20-A, forming a double wall as shown in FIG. 10 and constructed similarly. The double wall construction also has a door 110 for communication between the modules 20-A and 20-C the latter being with the aisle 95.

The cells 96 have lavatory facilities 112, and the module 20-C additionally has cubicles 114 with such articles as discharging, and the double access doors 108 referred to above for communication with an adjacent module connected to the outer end of the module 20-C.

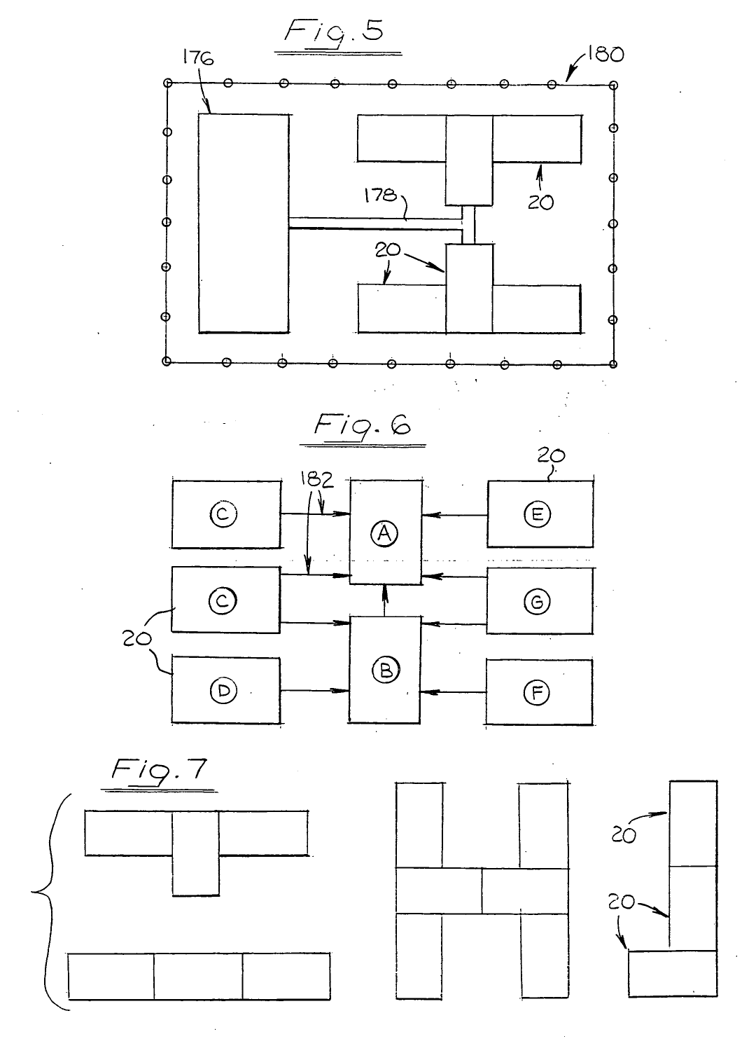

Attention is directed next to FIG. 7 showing a module constituting a day room for the detainees. The entire area of this module is given to recreation, and includes tables 160 with chairs 162 associated herewith. FIG. 11 shows a portion 162 of a leg of a table 160, anchored to the floor 26 in the manner shown in FIG. 8 at 40, thus anchoring the table securely to the floor.

As a further security, the chairs 162 may be hinged to the table for preventing them from being moved out of intended position. This arrangement is shown in FIG. 12 where a leg of the table is shown at 160, and a hinged construction 164 of known kind, is formed between the table and the chair, enabling the chair to be swung circumferentially to clear a space for a user to get in position for sitting in the chair. This prevents the chair from being dislodged and used as not intended.

FIG. 7 shows the module 20-D connected between other modules 20 in the manner of the other modules described above. In the present case doors 166 are provided to furnish communication between the day room and the adjacent modules 20. Single walls are shown at 168 and double walls at 170.

The day room also may include such furniture as easy chairs 172 and T.V. 174.

FIG. 13 is a detailed sectional view taken at line 13-13 of FIG. 3, of a finished wall at a junction between the bottom beam and the wall element supported thereby. The beam is shown at 42 and the wall panel at 44. This figure shows the wall panel welded at 166 to the bottom beam.

In all cases the I-beams resting on the floor are arranged with the web 168 disposed vertically.

All of the longitudinal pieces including the posts and beams in the frame structure are serially interconnected in a solid, rigid, total structure that cannot be misshaped from the intended final shape.

The structural pieces in the various modules are similar throughout. In the cases where a single wall piece 44 (FIG. 3) is put in place, it is welded to the beams below and above, as well as at the ends. This results in the in an effective one-piece structure. All of the modules taken together have single-wall, or double-wall, character and are secured together in a similar way throughout the entire structure.

FIGS. 4-6 show patterns of placement of the connected modules to show how they may be fitted to different installations.

In the diagram of FIG. 5 a permanent detention structure is shown at 176, at the left, and at the right, is a diagrammatic top view of various modules interconnected, and as a group, interconnected with the permanent structure 176. Communication lines 178 of any desired and known kind are provided between the two units i.e. the building 176 and the modules 20.

FIGS. 1 and 2 show a barbed wire security fence 180 surrounding a main structure of interconnected modules.

1. A detention structure made up of a plurality of modules each having elements of structure for treating personnel independently of the other modules,
the modules all being connectable together in a continuous structure wherein,
each module serves in its own independent function and also in combination with each of the modules to which it is connected.

2. A detention structure according to claim 1 for emplacement on the ground,
each module including a continuous concrete floor and an all-welded steel shell thereon, forming an interior space for detaining persons therein,
the shell being a framework of linear members and panels forming continuous wall members which together are impenetrable against the escape of persons.

3. A detention structure according to claim 1 wherein, each module has a lower part which forms a plurality of cells for occupancy by the detainees,
and an upper portion which is clear of the cells, and provides entirely open space for the transmission of radio communication lines.

4. A detention structure according to claim 1 wherein,
the cells in the various contiguous modules are adjacent a common height and the spaces above the cells form a contiguous space throughout the various interconnected modules.

5. A detention structure according to claim 1 wherein,
each module includes an upper framework and a floor of concrete,
the upper structure of linear steel elements being all welded together and spaced apart, thereby leaving spaces between adjacent linear elements, and
the frame structure includes flat panels covering the spaces between the linear elements, and
all of the interengaging ones of the linear elements and panels being welded together to form a unitary and integral structure.

6. A detention structure according to claim 5 wherein,
each of the elements of the frame structure has portions thereof embedded in the concrete floor.

7. A detention structure according to claim 6 wherein,
each module is a self-contained sub-structure of rectangular shape and is elongated, and the linear elements form vertical members disposed in rows longitudinally of the sub-structure, and such rows including a row at each of opposite sides of the sub-sturcture and at least one row in the middle between the side rows and extending higher than the linear elements of the side rows.

8. A detention structure according to claim 1 wherein,
at least certain of the modules include recreation areas, and furniture in such recreation areas, and,
the furniture in the recreational areas is positively secured to the floor of the module.

9. A detention structure according to claim 8, and including furniture which includes tables having legs with their lower ends positively secured in the floor of the module, and
chairs positively secured to the tables and swingable about hinges to respectively seating position at the table, and outwardly beyond such position to enable persons to move up to the edge of the table.

10. A detention structure according to claim 1 wherein,
each module has at least one single-element forming a wall, and a double wall element forming a double wall,
each of the single and double wall elements is positively secured to bottom and top elements of the frame structure.

11. A detention structure according to claim 10 wherein,
all of the linear elements are composed of I-beams, and those that are in horizontal position and forming beams in the frame structure, are arranged with their webs disposed vertically.

12. A detention structure according to claim 1 wherein,
the main structure has a concrete floor throughout its area,
each of certain modules thereof has an exit door to the exterior of the structure and
the final structure includes concrete pads at its exterior edges leading from said openings to the exterior of the structure.

13. A detention structure according to claim 1 wherein,
radio message transmission devices are incorporated in at least certain of the modules providing open spaces forming contiguous spaces for radio communications, and,
at least certain of the modules have instruments for transmitting such security radio waves through a plurality of contiguous areas relative to the modules.

14. A detention structure according to claim 1 in which,
the modules together provide facilities for detained persons such facilities including beds, lavatory facilities, kitchen, laundry, waste disposal, sleeping.

15. A detention structure according to claim 1 wherein,
at least certain of the modules have central aisles extending longitudinally, and living facilities on opposite sides of the central aisle.

16. A method of detaining personnel comprising,
providing a plurality of modules,
each of the modules having detention spaces therein and facilities for accommodating detainees individually,
securing at least certain of the modules together and thereby interconnecting the spaces in adjacent modules of identical characteristics so as to render each respective double space as a single space for communication of radio waves.

17. A method as set out in claim 16 and further including the steps,
providing a concrete base in each module, forming a floor in the respective modules, and all-welded-steel frame structure on the floor.

18. A method according to claim 17 and including the further step,
predetermining a ground space for accommodating a predetermined number of modules,
then placing the modules in position and interconnecting them at positions in the lines of engagement of adjacent modules.

19. A method according to claim 17 and including the additional steps,
predetermining a space in which the entire structure is to be emplaced,
leveling the ground predetermined for supporting the main structure, and
placing the modules on the concrete floor to form the main structure.
